(19) United States
(12) Patent Application Publication
(10) Pub. No.: US 2014/0104449 A1
(43) Pub. Date: Apr. 17, 2014

(54) IMAGING ADAPTER HEAD FOR PERSONAL IMAGING DEVICES

(71) Applicant: N2 Imaging Systems, LLC, Irvine, CA (US)

(72) Inventors: David Michael Masarik, Newport Beach, CA (US); Charles Francisco Wolcott, Fullerton, CA (US)

(73) Assignee: N2 Imaging Systems, LLC, Irvine, CA (US)

(21) Appl. No.: 14/055,764

(22) Filed: Oct. 16, 2013

Related U.S. Application Data
(60) Provisional application No. 61/715,205, filed on Oct. 17, 2012.

(51) Int. Cl. H04N 5/232; G03B 29/00; G03B 17/56

(52) U.S. Cl. CPC H04N 5/23203; G03B 17/565; G03B 29/00
USPC 348/211.14

(57) ABSTRACT

Some embodiments of an imaging adapter head are provided. The imaging adapter head can include a sensor module configured to detect levels of electromagnetic radiation within a field of view and output a corresponding digital or analog video signal. The imaging adapter head can include a micro-display module configured to receive the video signal and to generate an optical representation of the video signal. The imaging adapter head can include an optical coupling module having one or more lenses configured to create a focused virtual image of the optical representation and to position and size the focused virtual image such that, when the imaging adapter head is coupled to a personal imaging device having an optical image sensor, the optical representation of the field of view is completely imaged on the optical image sensor.

### CROSS-REFERENCE TO RELATED APPLICATIONS

This application claims the benefit of priority under 35 U.S.C. §119(e) of U.S. Provisional Patent Application No. 61/715,205, filed Oct. 17, 2012, entitled “IMAGING ADAPTER HEAD FOR PERSONAL IMAGING DEVICES,” the entire contents of which are incorporated by reference herein and made part of this specification.

### BACKGROUND

1. Field

This disclosure relates generally to systems and methods for acquiring and viewing images using a personal imaging device and to imaging adapter systems for use with personal imaging devices.

2. Description of Related Art

Imaging systems can produce images from electromagnetic radiation with various wavelengths and various intensities. One example is a digital camera that converts visible radiation into a digital signal using an image sensor such as a charge-coupled device (CCD) image sensor or an active-pixel sensor (APS) such as a complementary metal-oxide-semiconductor (CMOS) APS. Other imaging systems incorporate sensors configured to convert radiation from non-visible portions of the spectrum to electronic signals. For example, thermal imaging systems can incorporate cooled or uncooled thermal image sensors that convert infrared photons into an electronic signal. Such thermal sensors can be used to create visible images by detecting infrared radiation, converting the detected radiation into a temperature, and displaying the temperature as an intensity or color on a display. As another example, image intensifying systems can incorporate systems that convert photons to electrons and amplify the converted electrons to produce an amplified electronic signal. The amplified electronic signal can be read out by designated electronics and/or converted into visual information. Typically, imaging systems incorporate optics for directing or focusing incoming radiation onto an imaging sensor, internal logic modules to process the sensor data, a display for presenting the processed data, and interface elements for controlling the operation of the imaging system.

### SUMMARY

The systems, methods and devices of the disclosure each have innovative aspects, no single one of which is indispensable or solely responsible for the desirable attributes disclosed herein. Without limiting the scope of the claims, some of the advantageous features will now be summarized.

Some embodiments provide for an imaging adapter head including a sensor module configured to detect levels of electromagnetic radiation within a field of view and output a digital or analog video signal representing varying levels of the electromagnetic radiation within the field of view. The imaging adapter head can include a micro-display module configured to receive the digital or analog video signal and to generate an optical representation of the digital or analog video signal on a micro-display having a display image area. The imaging adapter head can include an optical coupling module having one or more lenses, wherein the one or more lenses are configured to create a focused virtual image of the optical representation and to position and size the focused virtual image such that, when the imaging adapter head is coupled to a personal imaging device having an optical image sensor, the optical representation of the field of view is completely imaged on the optical image sensor and a distance between the focused virtual image and the optical image sensor is greater than a distance between the micro-display and the optical image sensor.

In some embodiments, a personal imaging system includes an adapter head configured to optically couple a scene into a camera module of a personal imaging device and establish a digital data communications link with the personal imaging device The personal imaging system can include a personal imaging device having a personal device radio module and a camera module with an optical image sensor, wherein the camera module has a depth of field domain. The personal imaging system can include an imaging adapter head configured to operatively couple with the personal imaging device. The imaging adapter head can include an optical coupling module having one or more lenses, wherein the one or more lenses are configured to create a focused virtual image of a video output and to position the virtual image such that the focused virtual image is within the depth of field domain of the camera module. The imaging adapter head can include an imaging adapter radio module configured to establish a wireless digital data communications link with the personal device radio.

In some embodiments, a personal imaging system includes an adapter head with a micro-display that is optically coupled into a camera module of a personal imaging device. The personal imaging device can include a camera module with an optical image sensor configured to generate digital image data, wherein the camera module has a depth of field domain. The personal imaging device can include an imaging interface module configured to generate an image for display based on the digital image data. The personal imaging system can include an imaging adapter head configured to operatively couple with the personal imaging device. The imaging adapter head can include a micro-display module configured to receive a digital or analog video signal and to generate an optical representation of the digital or analog video signal on a micro-display having a display image area. The imaging adapter head can include an optical coupling module having one or more lenses, wherein the one or more lenses are configured to create a focused virtual image of a video output and to position the virtual image such that the focused virtual image is within the depth of field domain of the camera module.

### BRIEF DESCRIPTION OF THE DRAWINGS

The drawings are provided to illustrate example embodiments described herein and are not intended to limit the scope of the disclosure. Throughout the drawings, reference numbers may be re-used to indicate general correspondence between referenced elements.

FIG. 1 illustrates a block diagram of some embodiments of an imaging adapter head optically coupled to a camera of a personal imaging device.

FIG. 2A depicts an example embodiment of an imaging adapter head mechanically and optically coupled to a personal imaging device.

FIG. 2B illustrates an example embodiment of an optical module comprising a lens and a mirror.

FIG. 3 illustrates a block diagram of an imaging module according to some embodiments.

FIG. 4 illustrates a conversion of radiation in a field of view to an optical image using an imaging adapter head according to some embodiments.

FIG. 5 illustrates some embodiments of an imaging adapter head configured to convert image sensor data to an optical image suitable for optically coupling to a personal imaging device.

FIG. 6 illustrates some embodiments of an imaging adapter head comprising optical coupling elements and a radio for transmitting information to a personal imaging device.

FIG. 7 illustrates optically coupling a visible signal from a micro-display to a personal imaging device having a camera and an imaging interface module.

FIG. 8 illustrates optically coupling a visible signal from an imaging adapter head to a camera of a personal imaging device and wirelessly transmitting information between a radio of the imaging adapter head and a radio of the personal imaging device.

FIG. 9 illustrates a flow chart of some embodiments of a method for using an imaging adapter head.

FIG. 10 illustrates a flow chart of some embodiments of a method for controlling an imaging adapter head from a personal imaging device.

FIG. 11 illustrates a flow chart of some embodiments of a method for using an imaging adapter head to detect and display images suitable for coupling to a personal imaging device.

FIG. 12 illustrates a flow chart of some embodiments of a method for producing an optical image suitable for coupling with a personal imaging device.

FIG. 13 illustrates an example of an optical coupling module configured to position and size an image of a micro-display within a depth of field domain of a camera.

### DETAILED DESCRIPTION

Various aspects of the disclosure will now be described with regard to certain examples and embodiments, which are intended to illustrate but not to limit the disclosure. Nothing in this disclosure is intended to imply that any particular feature or characteristic of the disclosed embodiments is essential. The scope of protection of certain inventions is defined by the claims. Throughout the disclosure reference is made to thermography, thermographic imaging, thermal imaging systems, image intensifiers, image-intensified imaging, and other imaging systems in discussing imaging adapter heads. It is to be understood that these imaging systems and methods are a subset of imaging systems and methods to which this disclosure applies. Systems and methods described herein apply to imaging in various regions of the electromagnetic spectrum, such as, for example, gamma rays, x-rays, ultraviolet light, visible light, infrared radiation, microwaves, and/or radio waves. Furthermore, systems and methods described herein apply to other imaging modalities such as night vision systems utilizing thermal imaging and/or image-intensifying electronics.

Some embodiments provide for an imaging adapter head coupled to a personal imaging device, creating a personal imaging system. The personal imaging system can provide expanded or enhanced functionality to a camera or other imaging system on the personal imaging device. The personal imaging system can be used in applications such as, for example, medical imaging, night vision, transportation (e.g., consumer market cars, trucks, boats, and aircraft), research, quality and process control, surveillance and target tracking, personal vision systems, firefighting (e.g., provide an ability to see through smoke and/or detect hot spots), predictive maintenance on mechanical and electrical equipment (e.g., early failure warning), building and/or HVAC inspection, roof inspection, moisture detection in walls and roofs, search and rescue, quarantine monitoring of visitors to a location, nondestructive testing and surveillance, research and development, and/or radiometry.

### Overview of Imaging Adapter Heads

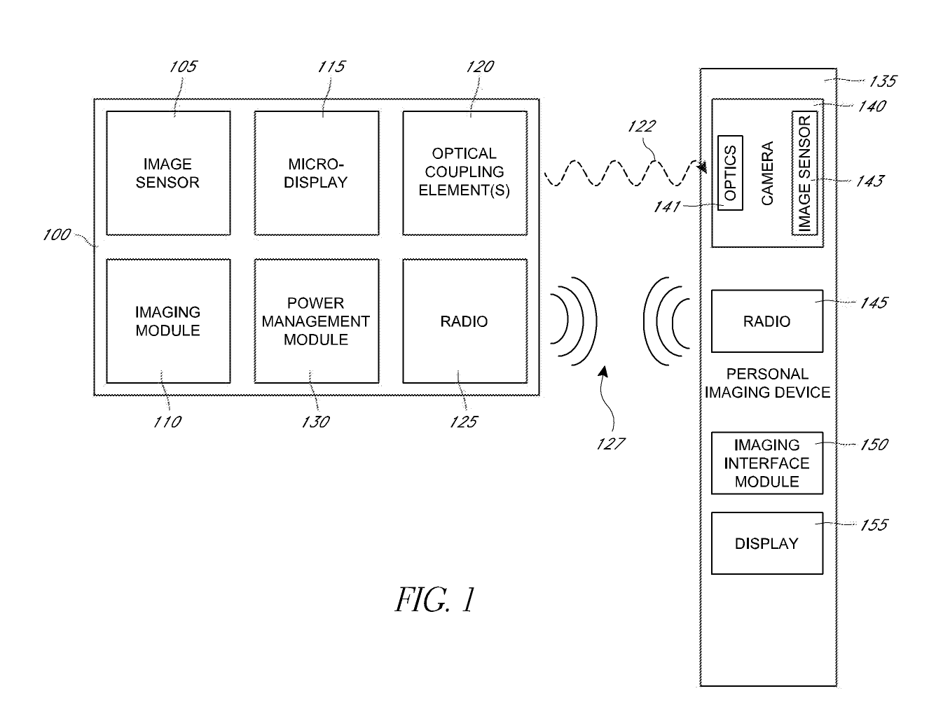

FIG. 1 illustrates a block diagram of an example imaging adapter head 100 optically coupled to a camera 140 of a personal imaging device 135. The personal imaging device 135 can be, for example, a cellular telephone, a PDA, a smartphone, a tablet, a laptop, a computer, another imaging system, or the like. The imaging adapter head 100 can be configured to detect radiation from a scene in a field of view and convert the detected radiation into an optical signal using a micro-display 115. The optical signal can be optically coupled to the camera 140 of the personal imaging device 135 using optical coupling elements 120. The optically coupled signal can be presented on a display 155 of the personal imaging device 135. In some embodiments, the imaging adapter head 100 comprises an apparatus configured to physically attach to a personal imaging device 135 (e.g., a cellular telephone) in such a way that the optical coupling elements 120 of the imaging adapter head apparatus 100 produce an image of the micro-display 115 within a depth of field of the camera 140.

In some embodiments, optically coupling the optical signal to the personal imaging device camera 140 advantageously leverages capabilities of the personal imaging device 135 to create a feature-rich, functional, and relatively low-cost expanded or enhanced imaging system. For example, the personal imaging device 135 can provide features and capabilities that include, without limitation, image processing, display, user interface elements, device control, data interaction, data storage, communication, localization and GPS capabilities, date and time stamping, data sharing, customized applications, or any combination of these.

In some embodiments, imaging capabilities of the personal imaging device 135 can be expanded or enhanced through the use of the imaging adapter head 100. For example, the personal imaging device 135 can be utilized as a thermal imaging system by coupling an embodiment of the imaging adapter head 100 configured to perform thermal imaging to the camera 140. The personal imaging device 135 can be utilized as a night vision device through by coupling an embodiment of the imaging adapter head 100 configured to perform image-intensified imaging.

The imaging adapter head 100 includes an image sensor 105 that can be configured to detect levels of electromagnetic radiation within a field of view and output a digital or analog video signal representing varying levels of the electromagnetic radiation within the field of view. The image sensor 105 can be configured to be sensitive to portions of the electromagnetic spectrum. For example, the image sensor 105 can be configured to respond to thermal radiation, short-wave infrared radiation (“SWIR”), near infrared radiation (“NIR”), visible radiation, ultraviolet (“UV”) radiation, or radiation in other parts of the electromagnetic spectrum. The image sensor 105 can be sensitive to radiation, for example, having a wavelength at least about 3 μm and/or less than or equal to about 14 μm, at least about 0.9 μm and/or less than or equal to about 2 μm, at least about 0.7 μm and/or less than or equal to about 1 μm, at least about 1 μm and/or less than or equal to about 3 μm, at least about 3 μm and/or less than or equal to about 5 μm, at least about 7 μm and/or less than or equal to about 14 μm, at least about 8 μm and/or less than or equal to about 14 μm, at least about 8 μm and/or less than or equal to about 12 μm, at least about 0.4 μm and/or less than or equal to about 1 μm, or less than or equal to about 0.4 μm. The image sensor 105 can be configured to respond to low light levels to produce an electric signal, such as an image intensifying image sensor or image sensor system.

The image sensor 105 can be configured to achieve desired functionality and/or characteristics. For example, the image sensor 105 can be configured to have a desired number of pixels, frequency of image acquisition or frame rate, power consumption, pixel pitch and count, response time, noise equivalent temperature difference (NETD), minimum resolvable temperature difference (MRTD), power dissipation, dynamic range, and/or size. In some embodiments, the image sensor 105 comprises a two-dimensional array of sensor elements. The two-dimensional array can be, for example, an array of 640 by 480 elements, 384 by 288 elements, 320 by 240 elements, 160 by 120 elements, 80 by 60 elements, 2000 by 1000 elements, 1280 by 1024 elements, or any other desirable array size. In some embodiments, the image sensor 105 is configured to acquire images at a desired frequency, including, for example, at least about 120 Hz, at least about 60 Hz, at least about 50 Hz, at least about 30 Hz, at least about 9 Hz, and/or less than or equal to about 9 Hz. In some embodiments, the image sensor 105 is a relatively low-power sensor. For example, the power dissipation of the image sensor 105 can be less than or equal to about 20 mW, at least about 20 mW and/or less than or equal to about 1 W, at least about 25 mW and/or less than or equal to about 500 mW, at least about 30 mW and/or less than or equal to about 300 mW, or at least about 50 mW and/or less than or equal to about 250 mW.

The imaging adapter head 100 includes an imaging module 110. The imaging module 110 can include hardware, firmware, and/or software configured to perform logical operations associated with the imaging adapter head 100. In some embodiments, the imaging module 110 is configured to store and retrieve data, perform calibration, control data acquisition on the image sensor 105, read data from the image sensor 105, convert sensor data for display on a micro-display 115, receive and process commands, execute commands, perform power management tasks, manage communication with the personal imaging device 135, control data sent over a radio 125, establish a communication link with the personal imaging device 135, perform image processing on sensor data (e.g., convert sensor data to grey-scale values or color values prior to display, transform data to an image having pixel redundancy on the micro-display, etc.), command the micro-display 115 to display a test pattern, or any combination of these.

In some embodiments, the imaging module 110 is configured to convert data from the image sensor 105 to monochrome values for display on the micro-display 115. The monochrome values can correspond to an intensity of radiation, a temperature, an average wavelength or frequency of light, or the like. In some embodiments, the imaging module 110 is configured to convert data from the image sensor 105 to color values for display on the micro-display 115. The color values can correspond to relative or absolute intensities in color channels of the image sensor 105 (e.g., red, green, and blue channels), temperature, intensity of radiation, or the like. Some embodiments can advantageously display color values corresponding to temperature which may provide accurate temperature information when optically coupled with a personal imaging device camera 140. In some embodiments, the imaging module 110 can switch between monochrome and color display modes.

In some embodiments, the imaging module 110 is configured to control and/or communicate with the image sensor 105, the micro-display 115, the power management module 130, the radio 125, or other components of the imaging adapter head 100 using defined input/output (I/O) protocols. For example, the imaging module 110 can receive data from the image sensor 105 and convert the data to an image to be displayed on the micro-display 115. The imaging module 110 can process information received by the radio 125 and send an appropriate signal to the radio 125 for transmission. The imaging module 110 can communicate with the power management module 130 and control the amount of power supplied to the image sensor 105, radio 125, micro-display 115, and/or other components of the imaging adapter head 100. In certain embodiments, the imaging module 110 is configured to send a defined input signal to the micro-display 115 based on a micro-display I/O protocol. In certain embodiments, the imaging module 110 can be configured to communicate with the radio 125 using a defined radio I/O protocol. In certain embodiments, the imaging module 110 communicates with a power supply or power management module 130 using a defined power management module I/O protocol. In some implementations, the I/O protocols of the image sensor 105, micro-display 115, radio 125, and power management module 130 are different from one another.

The imaging adapter head 100 includes a micro-display 115 that can be configured to receive a digital or analog video signal from the image sensor 105 or imaging module 110 and to generate an optical representation of the digital or analog video signal using a display image area. Electro-optical effects can be used to display image data on the micro-display 115 including, for example, electroluminescence (EL), transmissive liquid crystal effects (e.g., LCD), organic light emitting diodes (OLED), vacuum fluorescence, reflective liquid crystal effects (e.g., liquid crystal on Silicon (LCOS)), tilting or deforming of micro-mirrors (e.g., digital micro-mirror device (DMD)), or other similar electro-optical effects. The micro-display 115 can include addressing electronics such as an active matrix with integrated drivers. The micro-display 115 can conform to display standards such as, for example, SVGA, UVGA, SXGA, WUXGA, UXGA, VGA, QXGA, WVGA, HD 720, HD 1080, and the like. The viewing area of the micro-display 115 can have a width that is at least about 5 mm and/or less than or equal to about 40 mm, at least about 10 mm and/or less than or equal to about 30 mm, or at least about 16 mm and/or less than or equal to about 20 mm. The viewing area of the micro-display 115 can have a height that is at least about 4 mm and/or less than or equal to about 30 mm, at least about 7.5 mm and/or less than or equal to about 23 mm, or at least about 12 mm and/or less than or equal to about 15 mm. The viewing area of the micro-display 115 can be at least about 20 mm² and/or less than or equal to about 1200 mm², at least about 75 mm² and/or less than or equal to about 700 mm², or at least about 190 mm² and/or less than or equal to about 300 mm². The micro-display 115 can be monochrome or color.

The micro-display 115 can be configured to provide desired characteristics and/or functionality such as, for example, pixel pitch, contrast ratio, monochrome or color output, die size, luminance, and/or power dissipation. For example, a suitable micro-display 115 can be the MDP01A-P Maryland mono white OLED micro-display supplied by Microoled of Grenoble, France. This example micro-display can have about 1.7 million independent pixels arranged in a two-dimensional array. The native resolution of the micro-display can be 1746 by 1000 pixels and the micro-display can be configured to output an alternative resolution of 873 by 500 pixels to provide pixel redundancy. The example micro-display can have a pixel pitch of about 5 μm by 5 μm, an active area of about 8.7 mm by 5 mm, a die size of about 10.5 mm by about 9.53 mm. The example micro-display can have a contrast ratio of about 100,000 to 1, a luminance of between about 500 cd/m² and about 1000 cd/m², and typically consume about 25 mW.

The imaging adapter head 100 includes optical coupling elements 120 that can be configured to form an image of the micro-display 115 at a desired location. The desired location can be one that, when the imaging adapter head 100 is coupled to the personal imaging device 135, the image of the micro-display 115 formed by the optical coupling elements 120 falls within a desired depth of field of the camera 140 of the personal imaging device 135. A suitable depth of field can be a range of distances from the camera 140 that allows the camera 140 to focus an image of the micro-display 115 formed by the optical elements 120 on the image sensor of the camera 140. In some embodiments, the optical coupling components 120 comprise one or more lenses configured to create a focused virtual image of the micro-display 115 and to position and size the focused virtual image such that the focused virtual image is completely imaged on an image sensor of the camera 140. In certain embodiments, a distance between the focused virtual image created by the optical coupling components 120 and the optical image sensor of the camera 140 is greater than a distance between the micro-display 115 and the optical image sensor. In some embodiments, the optical coupling elements 120 comprise one or more optical components configured to create a focused virtual image of a video output of the micro-display 115 and to position the virtual image such that the focused virtual image is within a depth of field domain of the camera 140. For example, the optical coupling elements 120 can comprise a positive lens group having a positive total refractive power and the micro-display 115 can be positioned within a focal length of the optical coupling elements 120, thereby producing an enlarged virtual image. The optical coupling elements 120 can include, for example, one or more lenses, achromatic lenses, shutters, apertures, diffraction gratings, prisms, mirrors, lens arrays, wave plates, wave guides, optical fibers, other optical elements, or any combination of optical elements configured to form the desired image of the micro-display. The optical coupling elements 120 can include passive and/or active elements. The optical coupling elements 120 can be configured to have appropriate values for an associated camera 140. For example, the configuration of the optical coupling elements 120 can be based at least in part on Nyquist sampling considerations, a field of view of the camera 140, an aperture size of the camera 140, an f-number of the camera 140, and/or other properties of the camera 140.

The imaging adapter head 100 includes a radio 125 that can be electrically coupled to the imaging module 110 and/or other components of the imaging adapter head 100. The radio 125 can include components such as, for example, antennas, transceivers, processors, and the like. The radio 125 can be an ultra-wide band communication system, radio frequency communication system, BLUETOOTH™ communication system, near field communication system, or any combination of these or the like. The radio 125 can include one or more antennas configured to transmit and/or receive RF signals according to the IEEE 802.11 standard, including IEEE 802.11(a), (b), (g), or (n). In some embodiments, the radio 125 transmits and/or receives RF signals according to BLUETOOTH™ Specification Version 3.0+ HS adopted in 2009. In certain embodiments, the radio 125 transmits and/or receives CDMA, GSM, AMPS or other known signals that are used to communicate within a wireless cell phone network. In some embodiments, the radio 125 receives signals and manipulates the signals using a processor. In some embodiments, the signals sent and received by the radio 125 are processed by the imaging module 110. The radio 125 can be configured to establish a wireless communication link with a radio 145 on the personal imaging device 135.

In some embodiments, the imaging adapter head 100 establishes a communication link with the personal imaging device 135 using a cable connecting the imaging adapter head 100 to the personal imaging device 135. The cabled communication link can be used to communicate instructions, information, and data as described in relation to the wireless communication link. In some embodiments, the cabled communication link can be configured to provide power to the imaging adapter head 100. For example, a universal serial bus (“USB”) cable can be connected to both the imaging adapter head 100 and the personal imaging device 135 to provide a communication link and to provide power from the personal imaging device 135 to the imaging adapter head 100.

The imaging adapter head 100 includes a power management module 130 that can be configured to provide or direct power to the image sensor 105, thermal imaging module 110, micro-display 115, radio 125, active optical coupling elements 120, and/or other components of the imaging adapter head 100. The power management module 130 can be controlled by hardware, software, and/or firmware components included in the module or it can be controlled by the imaging module 110 or other components of the imaging adapter head 100.

In certain embodiments, the power management module 130 includes a power supply. For example, the power supply can be a rechargeable Lithium Ion battery. The power supply can be replaceable, such as with an additional or auxiliary power supply. For example, when the power supply runs low on power, an auxiliary power supply can be used to temporarily replace the power supply while it recharges. The power management module 130 can be configured to recharge the power supply using an external power source. For example, the imaging adapter head 100 can include a connector configured to receive a cable that can provide power to run the imaging adapter head 100 and/or recharge the power supply 130. In some embodiments, the imaging adapter head 100 is powered using an external power source wherein the power is provided via a cable. In some embodiments, the imaging adapter head 100 includes conductive pads coupled to the power supply and configured to contact an external source of power such that the conductive pads conduct power to the power supply to recharge it. In some embodiments, the power supply can be recharged through wireless means. The power management module 130 can be coupled to user interface elements that allow a user to put the imaging adapter head 100 into a different power mode, such as, for example, to turn the system off or on, to put the system in a stand-by mode, a power-saving mode, a sleep mode, a hibernate mode, or the like.

The imaging adapter head 100 can be optically coupled to the camera 140 of the personal imaging device 135 wherein the camera 140 includes optics 141 (e.g., one or more lenses) and image sensor 143. The camera 140 can have a depth of field domain that is defined, at least in part, by the camera's optics 141 and/or image sensor 143 The depth of field domain for the camera 140 can be a range of distances from the camera 140 such that the optics 141 can create a focused image of an object positioned within the depth of field domain and position the focused image onto the camera's image sensor 143. Optically coupling the imaging adapter head 100 to the personal imaging device 135 can include using the optical coupling elements 120 to create a virtual focused image of an output signal of the micro-display 115 within the depth of field domain of the camera 140. In some embodiments, the optics 141 of the camera 140 include one or more lenses that have a composite focal length of at least about 2 mm and/or less than or equal to about 8 mm, at least about 3 mm and/or less than or equal to about 6 mm, or at least about 3.5 mm and/or less than or equal to about 5 mm. The aperture of the camera 140 can be, for example, f/2.0, f/2.4, f/2.6, f/2.8, f/3.0, f/3.2, or other similar value. The image sensor 143 of the camera 140 can be an active pixel sensor (e.g., CMOS sensor) or other similar image sensor (e.g., CCD image sensor). The image sensor 143 of the camera 140 can have a number of pixels, for example the sensor can have at least about 1 million pixels and/or less than or equal to about 20 million pixels, at least about 1.5 million pixels and/or less than or equal to about 12 million pixels, or at least about 2 million pixels and/or less than or equal to about 10 million pixels.

By optically coupling the output signal from the micro-display 115 to the camera 140, capabilities of the personal imaging device 135 can be leveraged through the imaging interface module 150. For example, the imaging interface module 150 can use the display 155 of the personal imaging device 135 to display the output signal from the micro-display 115 to a user, thereby providing the user with a real-time view of image and/or video data detected by the imaging adapter head 100. The imaging interface module 150 can provide image processing capabilities to manipulate, analyze, store, and/or display the coupled optical signal received by the camera 140. The imaging interface module 150 can provide user interface elements displayed to the user on the display 155 such that the user can control functionality of the imaging adapter head 100 through interactions with the user interface elements. The imaging interface module 150 can present an application interface to the user of the personal imaging device 135 such that the user can view images or video acquired by the imaging adapter head 100 and perform desired tasks such as, for example, display the images being received by the camera 140 through the display 155, save images or video, send images to other personal imaging devices, e-mail images, store GPS information with images, store date and/or time information with images, store ambient temperature information from the imaging adapter head 100, connect with other applications on the personal imaging device 135, colorize images from the micro-display 115 based on calibration data, provide access to adapter controls via the wireless communication link, or any other similar function or combination of functions.

The imaging adapter head 100 can be mechanically coupled to the personal imaging device 135. Mechanically coupling the imaging adapter head 100 to the personal imaging device 135 can comprise substantially securing the imaging adapter head 100 to the personal imaging device 135 in a desired position and/or orientation such that the camera 140 of the personal imaging device 135 can focus the focused virtual image produced by the optical elements 120, as described more fully herein. In certain embodiments, the imaging adapter head 100 includes, for example, clips, bands, claims, conformable materials, adhesives, and the like for mechanically coupling to the personal imaging device 135. In certain embodiments, elements used to couple the imaging adapter head 100 can be physically separate from the imaging adapter head 100 when it is not coupled to the personal imaging device 135. Components used to mechanically couple the personal imaging device 135 and the imaging adapter head 100 can include, for example, a corner clip, a molded plastic element that is shaped to fit over a portion of the personal imaging device 135, an elastic band, clamps, a conformable mount, an adhesive present on one or both systems, or any combination of these.

The imaging adapter head 100 can create a wireless communication link with the radio 145 personal imaging device 135. The personal imaging device radio 145 can be configured to communicate with the radio 125 of the imaging adapter head 100 to establish a wireless communication link using wireless communication protocols and standards, as described more fully herein.

### Example Imaging Adapter Head

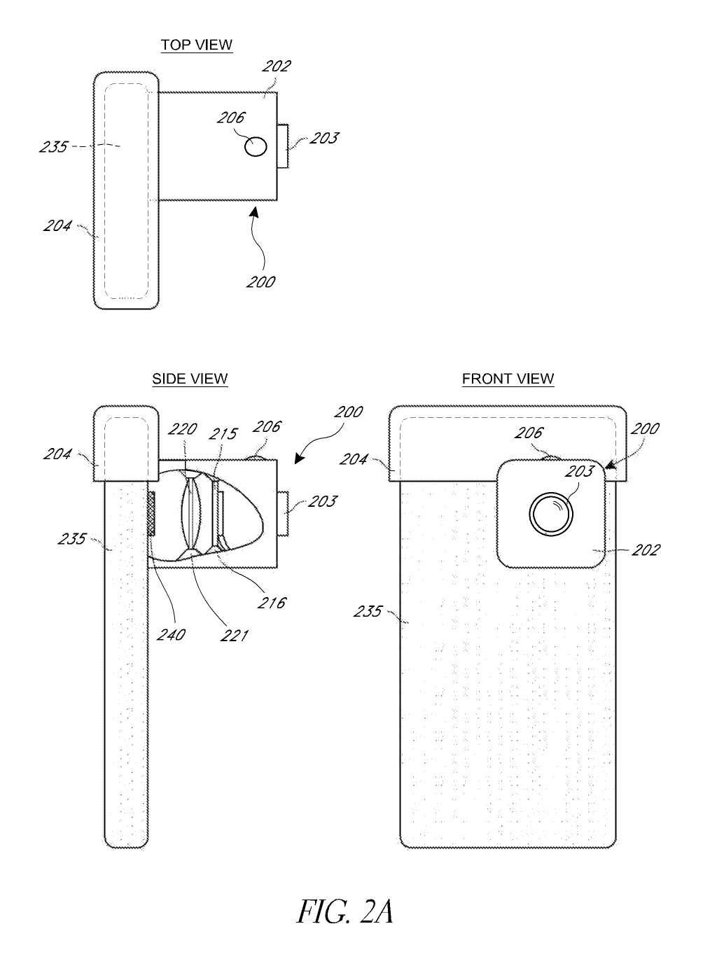

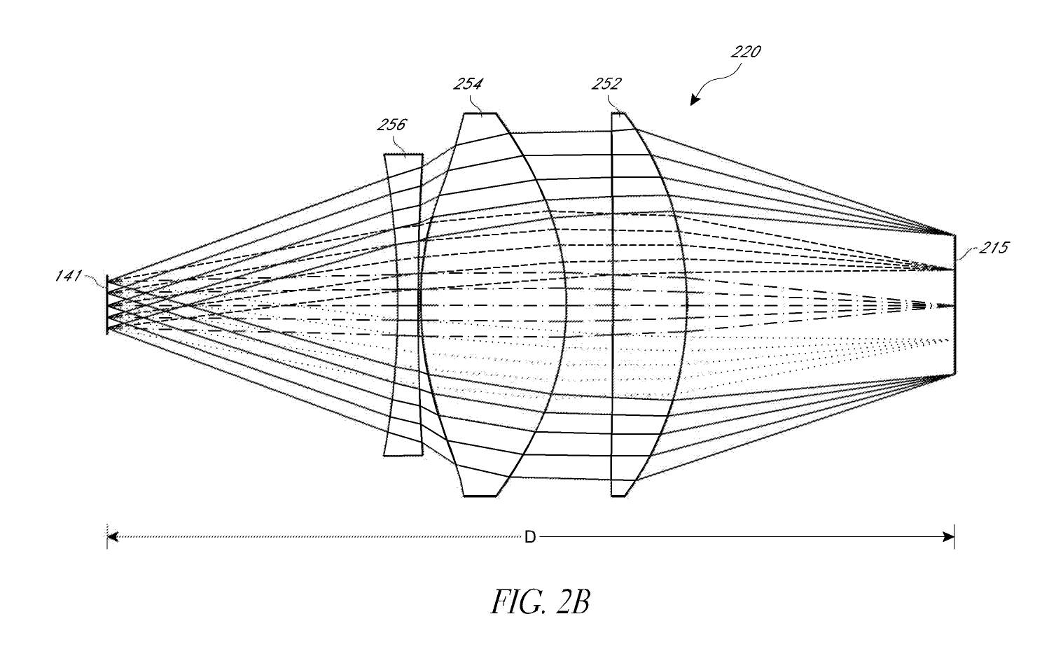

FIG. 2A depicts an example embodiment of an imaging adapter head 200 mechanically and optically coupled to a personal imaging device 235. The imaging adapter head 200 includes a mechanical coupling member 204 that is configured to position the imaging adapter head 200 relative to a personal imaging device camera 240 such that the camera 240 can capture a focused image of an imaging adapter head micro-display 215.

The imaging adapter head 200 comprises a housing 202 and imaging optics 203. The housing 202 can be configured to house components of the imaging adapter head 200 and to secure those components in desired positions. For example, the housing 202 can secure the imaging optics 203 such that the imaging optics 203 direct electromagnetic radiation onto a sensor module (not shown) which in turn can be configured to detect levels of electromagnetic radiation within a field of view and output a digital or analog video signal representing varying levels of the electromagnetic radiation within the field of view.

The imaging adapter head 200 includes mechanical coupling member 204 configured to secure the imaging adapter head 200 to a personal imaging device 235. The mechanical coupling member 204 can be a rigid member having a cavity with a shape that is complementary to a personal imaging device 235. For example, the personal imaging device 235 can be inserted into the cavity of the mechanical coupling member 204 such that the imaging adapter head 200 is substantially secured in a desired position. The mechanical coupling member 204 can include clamps, flexible bands, spring clips, or other similar features configured to secure the imaging adapter head 200 to the personal imaging device 235. The mechanical coupling member 204 can be configured to couple to a particular personal imaging device 235 or to a particular class of personal imaging devices, or it can be configured to have an adaptable structure that allows the imaging adapter head 200 to be mechanically coupled to a variety of personal imaging devices. In some embodiments, the mechanical coupling member 204 is self-aligning such that when the imaging adapter head 200 is mechanically coupled to the personal imaging device 235, coupling optics 220 create a focused virtual image of the micro-display 215 within a depth of field of the camera 240 wherein the focused virtual image is completely imaged on an image sensor of the camera 240. In some embodiments, the mechanical coupling member 204 is configured to allow the housing 202 to be moved while it is mechanically coupled to the personal imaging device 235 so that the alignment of the coupling optics 220, the micro-display 215, and the camera 240 can be adjusted.

The imaging adapter head 200 includes user interface components 206 configured to allow a user to control or interact with the imaging adapter head 200. User interface components 206 can be coupled to the housing 202 such that a user can access the user interface components 206 to input commands to the imaging adapter head 200. As illustrated in FIG. 2, the user interface components 206 can be a physical feature on the housing 202 such as a button. In some embodiments, the user interface components 206 can be, for example, a touch-sensitive element, a joystick, a switch, a toggle, or a combination of any of these elements. The user interface components 206 can be configured to turn the imaging adapter head 200 on, off, or put it in a stand-by or power-saving mode. The user interface components 206 can be provided through a combination of visual or optical signals, such as menus or information displayed on the micro-display 215, and physical elements 206, such as directional pads, joysticks, keyboards, buttons, or the like. In certain embodiments, the user interface components 206 trigger the imaging adapter head 200 to display a menu on the micro-display 215. If the micro-display 215 is optically coupled to the personal imaging device 235, the menu can be displayed on a display of the personal imaging device 235. In that way, a user can interact with a menu system on the imaging adapter head 200 to accomplish various tasks. In certain embodiments, the user can interact with the imaging adapter head 200 through a menu displayed on the micro-display 215 through the use of an eyepiece rather than or in addition to using the display on the personal imaging device 235.

Inside the imaging adapter head housing 202, the micro-display 215 and coupling optics 220 can be positioned and oriented to create a focused virtual image within a depth of field of the camera 240. The micro-display 215 can be secured within the housing using micro-display support structures 216. The coupling optics 220 can be secured within the housing using optical support structures 221. The support structures 216 and 221 can be configured to secure the respective components at a desired position relative to each other and relative to the personal imaging device camera 240. When coupled to the personal imaging device 235, the combination of the micro-display 215 and coupling optics 220 can optically couple a visual signal from the micro-display 215 to the camera 240, thereby providing the user a real-time view of images or video captured by the imaging adapter head 200 using the display of the personal imaging device.

In some embodiments, the imaging adapter head 200 includes a radio module configured to establish a wireless communication link with the personal imaging device, as described more fully herein. In some embodiments, the imaging adapter head 200 includes a power supply configured to provide power to components of the imaging adapter head 200, as described more fully herein.

FIG. 2B illustrates an example embodiment of coupling optics 220 of the imaging adapter head 200, the coupling optics 220 comprising lenses 252, 254, and 256. The coupling optics 220 can be configured to produce an image of the micro-display 215 within a depth of field of a personal imaging device camera physically coupled to the imaging adapter head 200. The coupling optics 220 can be a color-corrected wide field-of-view (“WFOV”) relay optic. The coupling optics 220 can present a collimated WFOV display image to optics 141 of the mobile device camera 240. The coupling optics 220 can be implemented utilizing conventional designs which include, for example, glass lenses, polymer lenses, and/or hybrid lenses. The coupling optics 220 can be configured to be suitable for a 40 degree field-of-view (“FOV”), 45 degree FOV, or other FOV. The coupling optics 220 can be relatively lightweight through the use of lightweight polymer elements. The coupling optics 220 can be configured to deliver a relatively high modulation transfer function (“MTF”) over the display field. Per the example coupling optics 220 illustrated in FIG. 2B, the coupling optics 220 can be relatively rugged through the use of protective elements or external elements. The coupling optics 220 can comprise a molded aspheric polymer element 254 between two relatively low cost spherical glass elements 252, 256. The glass elements 252, 256 can be configured to assure a relatively robust external optical surface for the coupling optics 220 and to protect the molded aspheric polymer element 254 that provides much of the WFOV, MTF performance, and/or color correction.

The coupling optics 220 can be configured to provide a suitable image of the micro-display 215 along an optical path that is less than or equal to a length D from the micro-display 215 to the mobile device camera optics 141. The length D can be less than or equal to about 50 mm, less than or equal to about 35 mm, less than or equal to about 30 mm, less than or equal to about 25 mm, or less than or equal to about 20 mm. Both the height and width of the coupling optics 220 can be less than or equal to about a 25 mm, less than or equal to about 20 mm, less than or equal to about 15 mm, less than or equal to about 12.5 mm, or less than or equal to about 5 mm. Thus, the volume of an image coupling module comprising the micro-display 215, the coupling optics 220, and the mobile device camera optics 141 can be less than or equal to about 32 cm³, less than or equal to about 20 cm³, less than or equal to about 10 cm³, or less than or equal to about 4 cm³. The volume of the image coupling module can be reduced as micro-display pixel sizes become smaller and/or as the FOV of the coupling optics 220 increases where the design of the coupling optics 220 and the micro-display 215 can be configured to match desired mobile device camera optics 141. The coupling optics 220 can include suitable athermalization features such as, for example, manual focus or passive athermalization. In some embodiments, the coupling optics 220 can be implemented as wafer-scale optics using, for example, advanced compound moldable optics. Implementing wafer-scale optics can decrease a size of the coupling optics 220 such that the length D can be less than or equal to about 5 mm, less than or equal to about 3.5 mm, or less than or equal to about 2 mm.

### Example Imaging Module

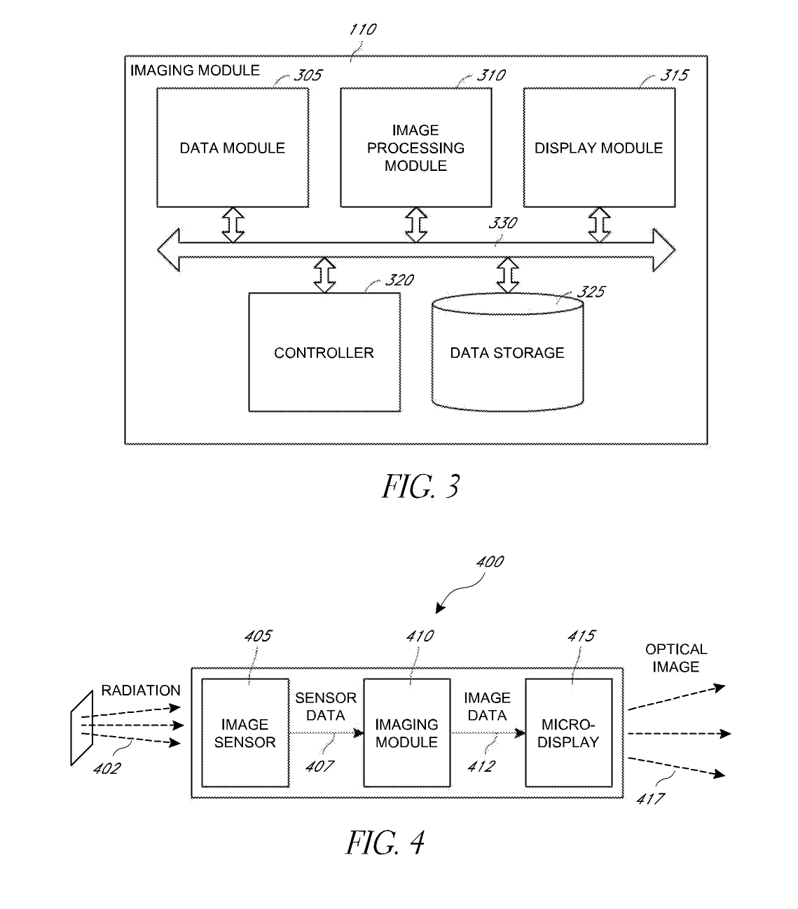

FIG. 3 illustrates a block diagram of an imaging module 110 according to some embodiments. The imaging module 110 can include hardware, software, and/or firmware components used to control the imaging adapter head 100. The imaging module 110 can provide desired functionality to the imaging adapter head 100 and can communicate with other components of the imaging adapter head 100. For example, the imaging module 110 can receive video or image data from the image sensor 105, process the data, and transmit a corresponding video signal to the micro-display 115. The imaging module 110 can accept input signals from components such as, for example, the image sensor 105, the micro-display 115, the radio 125, the power management module 130, and/or other components on the imaging adapter head 100. The imaging module 110 can communicate output signals to components such as, for example, the image sensor 105, the micro-display 115, the radio 125, the power management module 130, and/or other components on the imaging adapter head 100.

The imaging module 110 can include a data module 305, an image processing module 310, a display module 315, a controller 320, and data storage 325. The components of the imaging module 110 can communicate with one another and with other components of the imaging adapter head over communication bus 330.

The data module 305 can be configured to process data associated with the imaging adapter head 100. The data can include calibration data, temperature data, non-image sensor data, data associated with components of the imaging adapter head 100, and the like. In certain embodiments, the data module 305 serves to respond to requests from other components of the imaging module 110 for data. For example, the image processing module 310 can request calibration data during an image processing procedure. The data module 305 can receive the request and retrieve the appropriate data from data storage 325. The data module 305 can receive requests for data from the personal imaging device 135 through the radio 125 or other communication link. The data module 305 can respond to requests from the personal imaging device 135 by retrieving requested information, processing it, and/or communicating the information to the radio 125 for transmission. The data module 305 can be configured to establish a communication link between the imaging adapter head 100 and the personal imaging device 135. In some embodiments, the data module 305 can be used to encode and decode information to and from the radio 125. In certain embodiments, the data module 305 can receive control instructions and perform requested functions. For example, the data module 305 can receive a calibration request and, in response, perform a calibration procedure. In certain embodiments, the data module 305 controls data acquisition of the image sensor 105.

The image processing module 310 can be configured to receive image sensor data from the image sensor 105 and process it. In some embodiments, the image processing module 310 receives image sensor data and converts the image sensor data to an array of digital values to be displayed on the micro-display 115. For example, the image processing module 310 can convert data from the image sensor 105 to grey-scale values or color values prior to display The image processing module 310 can receive data from the data module 305 for use in processing image data from the image sensor 105.

The display module 315 can be configured to receive information from the image processing module 310 and convert it into an appropriate format for display on the micro-display 115. For example, the display module 315 can determine a range of pixels to use to display the image sensor data. The display module 315 can receive data from the image processing module 310, convert it into an appropriate analog or digital signal, and send this converted signal to the micro-display 115. In certain embodiments, the display module 315 receives data from the data module 305 and instructs the micro-display 115 to display a test pattern or other defined pattern. This can be used during calibration or alignment procedures, such as when attempting to mechanically couple the image adapter head 100 to the personal imaging device 135.

The controller 320 can include one or more processors and can be used by any of the other components, such as the data module 305, the image processing module 310, or the display module 315 to process information. As used herein, the term “processor” refers broadly to any suitable device, logical block, module, circuit, or combination of elements for executing instructions. The controller 320 can be any conventional general purpose single- or multi-chip microprocessor such as a Pentium® processor, a MIPS® processor, a Power PC® processor, AMID® processor, or an ALPHA® processor. In addition, the controller 320 can be any conventional special purpose microprocessor such as a digital signal processor. The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor, such as controller 320, can be a conventional microprocessor, but the controller 320 can also be any conventional processor, controller, microcontroller, or state machine. Controller 320 can also be implemented as a combination of computing devices, e.g., a combination of a DSP and a microprocessor, a plurality of microprocessors, one or more microprocessors in conjunction with a DSP core, or any other such configuration.

Data storage 325 can be coupled to the other components of the imaging module 110, such as the controller 320, the data module 305, the image processing module 310, and the display module 315. Data storage 325 can refer to electronic circuitry that allows information, typically computer data, to be stored and retrieved. Data storage 325 can refer to external devices or systems, for example, disk drives or solid state drives. Data storage 325 can also refer to fast semiconductor storage (chips), for example, Random Access Memory (RAM) or various forms of Read Only Memory (ROM), which are directly connected to the one or more processors of the imaging module 110. Other types of memory include bubble memory and core memory.

### Example Imaging Systems

FIG. 4 illustrates functionality of an example embodiment of an imaging adapter head 400. The imaging adapter head 400 comprises an image sensor 405, an imaging module 410, and a micro-display 415. These components are similar to those described herein with specific reference to FIGS. 1-3. The imaging adapter head 400 can be configured to detect a level of radiation 402 in a scene. The image sensor 405 can convert the level of radiation 402 into digital or analog sensor data 407 which is passed to the imaging module 410. The imaging module 410 can be configured to process the digital or analog sensor data 407 to produce digital or analog image data 412 for display on the micro-display 415. The micro-display 415 can produce an optical image or video signal 417 based at least in part on the image data 412 received from the imaging module 410. In some embodiments, the output of the micro-display 415 can be representative of information from a scene. For example, the color and/or intensity of a displayed pixel in the micro-display 415 can represent a temperature, position, reflectivity, and/or intensity of radiation 402 in the scene.

In some embodiments, a user can view the output signal of the imaging adapter head 400 using various devices or systems. For example, the user can use a personal imaging device to view the output signal, as described more fully herein. An eyepiece can be coupled to the imaging adapter head 400 and the user can use their eye to see the image produced by the combination of the eyepiece and imaging adapter head 400. A camera, such as a video or still camera, can be used to view the output signal of the imaging adapter head 400. In certain embodiments, the imaging adapter head 400 is configured to be an adapter for a security camera. For example, the imaging adapter head 400 can include a thermal sensor 405 and can be optically coupled to a security camera such that the security camera can be used to visualize thermal information detected by the imaging adapter head 400.

In some embodiments, the imaging adapter head 400 is configured to achieve a desirable small form factor, to consume a reduced amount of power, to provide secure data delivery, or to provide other desired functionality. For example, the imaging adapter head 400 can be configured to receive power through an external power source, such as through a connected cable delivering electric current from a battery or other device, allowing the removal of internal power sources and/or components related to a power management module. The imaging adapter head 400 can be configured to establish a communication link with a personal imaging device (not shown) or other device through a cable, allowing the removal of a radio and associated components.

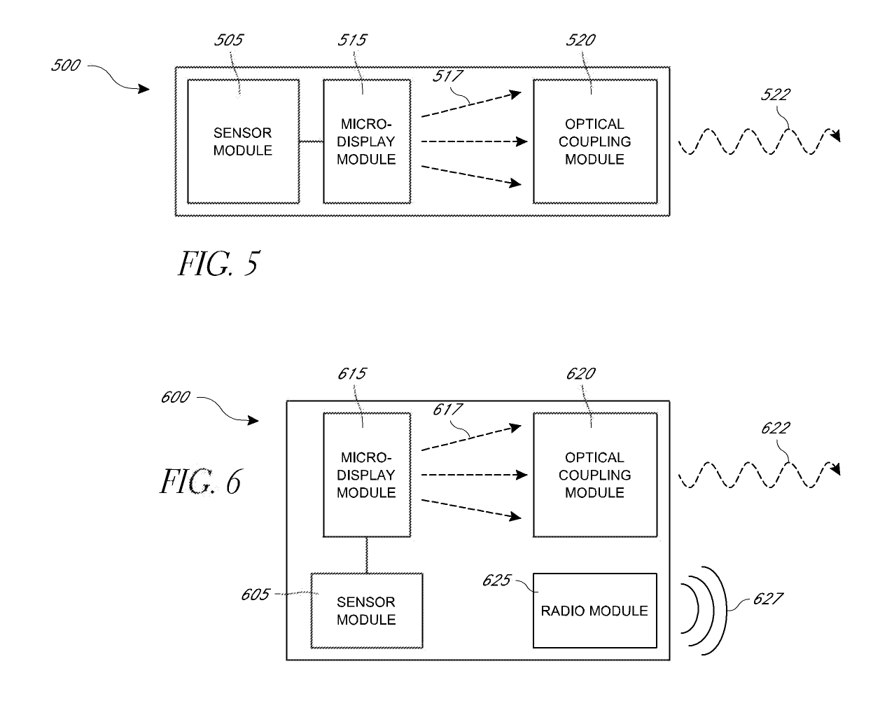

FIG. 5 illustrates an example embodiment of an imaging adapter head 500. The imaging adapter head 500 includes a sensor module 505, a micro-display module 515, and an optical coupling module 520. The sensor module 505 can be configured to detect levels of electromagnetic radiation within a field of view and output a digital or analog video signal representing varying levels of the electromagnetic radiation within the field of view. In some embodiments, the sensor module 505 includes one or more image sensors. The one or more image sensors can be configured to provide different functionalities to the imaging adapter head 500. For example, the sensor module 505 can include an image sensor and associated optics configured to detect thermal radiation, as described more fully herein. The sensor module 505 can include an image sensor and associated optics configured to detect low levels of radiation, such as an image intensifier. Some embodiments of the imaging adapter head 500 advantageously provide for an imaging system that can cover multiple spectral ranges. Some embodiments of the imaging adapter head 500 advantageously provide for an imaging system that can be utilized in varied lighting conditions, such as night time use, day time use, indoor use, and/or outdoor use.

The imaging adapter head 500 includes the micro-display module 515 which can be configured to receive the digital or analog video signal from the sensor module 505 and to generate an optical representation of the digital or analog video signal 517 on a display image area. The optical coupling module 520 of the imaging adapter head 500 can include one or more lenses configured to create a focused virtual image 522 of the generated optical representation 517 and to position and size the focused virtual image 522 such that, when the imaging adapter head 500 is coupled to a personal imaging device having an optical image sensor (not shown), the optical representation of the field of view 517 is completely imaged on the optical image sensor. In some embodiments, a distance between the focused virtual image 522 and the optical image sensor (not shown) is greater than a distance between the micro-display module 515 and the optical image sensor (not shown). Some embodiments of the imaging adapter head 500 advantageously provide for a flexible and powerful imaging system by optically coupling signals 517 from the micro-display 515 to a personal imaging device. For example, the imaging capability of the personal imaging device can be expanded to include thermal imaging capabilities and/or night-vision capabilities.

The micro-display module 515 can be used to display information in addition to image data acquired by the sensor module 505. In some embodiments, the sensor module 505 acquires image data with a number of sensor pixels and the micro-display module 515 has a number of display pixels that is greater than the number of sensor pixels. These additional display pixels can be used to display information that can be read by a user, a personal imaging device, or both. In some embodiments, the micro-display module 515 can display information overlaid and/or interleaved with the acquired image data. The information displayed can be textual (e.g., presenting an operating temperature, battery percentage value, date, time, or the like), graphical (e.g., presenting a bar code, QR code, battery status icon, other icons, or the like), or otherwise encoded in the acquired image data (e.g., varying a brightness, intensity, or color of a presented image). In some embodiments, the information displayed is imperceptible to a human.

FIG. 6 illustrates an example embodiment of an imaging adapter head 600 similar to the imaging adapter head 500 described with specific reference to FIG. 5 The imaging adapter head 600 includes a radio module 625 in addition to a sensor module 605, a micro-display module 615, and an optical coupling module 620 which are similar to the corresponding elements of the imaging adapter head 500 described herein with reference to FIG. 5. The imaging adapter head 600 includes the radio module 625 comprising one or more antennas and a transceiver, wherein the radio module 625 is configured to establish a wireless digital communication link 627 with a radio of a personal imaging device (not shown), as described herein above with reference to FIG. 1.

In certain embodiments, the radio module 625 of the imaging adapter head 600 is configured to receive control information from a device with which it has formed a wireless digital communication link 627. The radio module 625 can communicate received control information to components of the imaging adapter head 600. Some embodiments of the imaging adapter head 600 can be controlled through the personal imaging device by providing a user an ability to send control commands to the imaging adapter head 600 through the wireless digital communication link. Thus, some embodiments of the imaging adapter head 600 reduce or eliminate external user interface elements allowing the imaging adapter head 600 to be reduced in size and/or complexity. In certain embodiments, the radio module 625 of the imaging adapter head 600 is configured to send data to the linked personal imaging device, wherein the data can include, for example, calibration data, environmental temperature, battery status, error codes, operational parameters, component information, control options, system information, and the like.

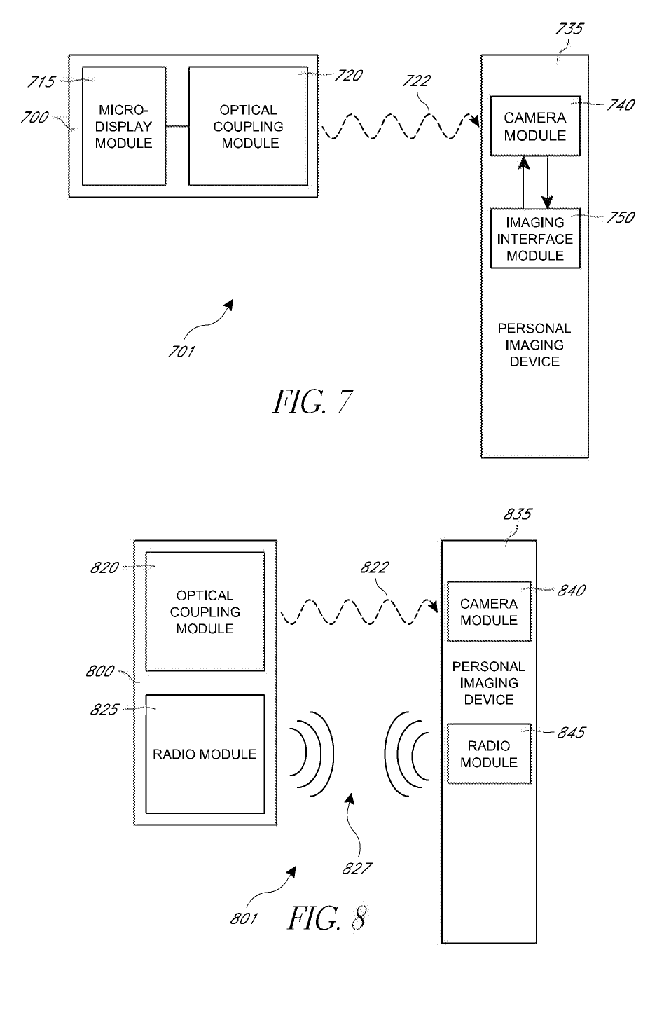

FIG. 7 illustrates an example embodiment of a personal imaging system 701 configured to optically couple a visible signal 722 to a camera module 740 of a personal imaging device 735. The personal imaging system 701 includes a personal imaging device 735 and an imaging adapter head 700. The personal imaging device 735 includes a camera module 740 having an optical image sensor (not shown) configured to generate digital image data, wherein the camera module 740 has a depth of field domain. The personal imaging device 735 includes an imaging interface module 750 configured to generate an image for display based on the digital image data. The personal imaging system 701 includes the imaging adapter head 700 configured to operatively couple with the personal imaging device 735. The imaging adapter head 700 includes a micro-display module 715 configured to receive a digital or analog video signal and to generate an optical representation of the digital or analog video signal on a display image area. The imaging adapter head 700 includes an optical coupling module 720 having one or more lenses, wherein the one or more lenses are configured to create a focused virtual image 722 of a video output or other optical signal and to position the virtual image 722 such that the focused virtual image 722 is within the depth of field domain of the camera module 740.

Some embodiments of the imaging adapter head 700 allow the micro-display module 715 to receive the digital or analog video signal from any appropriate source. For example, the micro-display module 715 can receive the digital or analog video signal from an image sensor, from another imaging system, from a radio module, from another camera, from a computer, from a video system, or the like. Thus, some embodiments of the imaging adapter head 700 advantageously provide for a flexible and expandable personal imaging system 701 capable of leveraging capabilities and advantages of the personal imaging device 735. For example, the imaging interface module 750 of the personal imaging device 735 can provide image analysis, processing, and/or storage capabilities that are built into the phone. As a result, the personal imaging system 701 can provide relatively advanced and robust image analysis functionality without requiring that the hardware and software configured for such analysis be present in the imaging adapter head 700, thereby reducing the cost of developing and producing the imaging adapter head 700.

FIG. 8 illustrates an example embodiment of a personal imaging system 801 comprising an image adapter head 800 configured to optically couple a visible signal 822 to, and to establish a wireless communication link 827 with, a personal imaging device 835. The personal imaging device includes a personal device radio module 845 and a camera module 840, wherein the camera module 840 has a depth of field domain. The imaging adapter head 800 can be configured to operatively couple with the personal imaging device 835. The imaging adapter head 800 includes an optical coupling module 820, wherein the optical coupling module 820 can include one or more lenses. The optical coupling module 820 can be configured to create a focused virtual image 822 of a video output or other optical signal and to position the focused virtual image 822 such that the focused virtual image 822 is within the depth of field domain of the camera module 840. The imaging adapter head 800 includes an imaging adapter radio module 825 configured to establish a wireless digital data communications link 827 with the personal device radio module 845.

As described herein with reference to FIGS. 1 and 6, the wireless digital data communications link 827 can be used to transmit data between the imaging adapter head 800 and the personal imaging device 835. The data to be wirelessly transmitted can include, for example, calibration data, environmental temperature, battery status, error codes, operational parameters, component information, control options, system information, and the like. The data can be selected to complement the visual data transmitted to the camera module 840 using the optical coupling module 820. In some embodiments, the wireless digital data communications link 827 provides a user the ability to control the imaging adapter head 800 using the personal imaging device 835. Locating the control functionality on the personal imaging device 835 can remove or reduce a need to put user interface elements on the imaging adapter head 800. This can allow the imaging adapter head 800 to achieve a smaller form-factor due at least in part to the reduced number of on-board user interface elements. Furthermore, the wireless digital data communications link 827 can provide communication capabilities without the need for a wired connection between the imaging adapter head 800 and personal imaging device 835. This can remove or reduce a need to put connector elements on the imaging adapter head 800, contributing to the smaller form-factor.

Thus, some embodiments of the personal imaging system 800 provide for data related to detected levels of electromagnetic radiation within a field of view to be optically transmitted to the personal imaging device 835 and other data to be wirelessly transmitted to the personal imaging device 835 using the wireless digital communication link 827. Thus, the relatively large amount of data associated with the detected levels of radiation can use a relatively high bandwidth communication scheme, e.g., using video output optically coupled to the camera 840 to communicate this information, and other data can use the wireless digital communication link 827. In some embodiments, the wireless digital data communications link 827 is a low-power and short-range communication link utilizing low-bandwidth. As a result, the personal imaging device radio 845 can use available bandwidth not used by the wireless digital communication link 827 for other purposes.

### Example Method of Using an Imaging Adapter Head

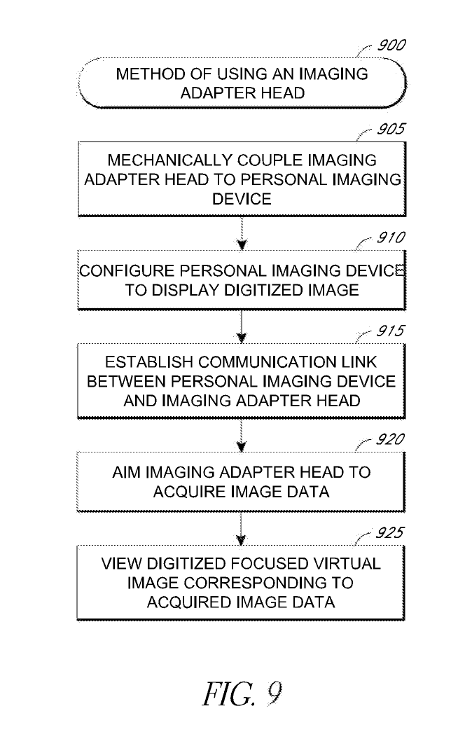

FIG. 9 illustrates a flow chart of an example method 900 for using some embodiments of an imaging adapter head. In certain embodiments, the imaging adapter head is used with a personal imaging device having a camera module and a display. Using the imaging adapter head in combination with the personal imaging device can create a personal imaging system that has enhanced or extended capabilities relative to the personal imaging device alone. For ease of description, the method 900 is described as being performed by a user. However, steps in the method 900 can be performed by, for example, the user, components or modules of the imaging adapter head, components or modules of the personal imaging device, and/or another entity.

In block 905, a user mechanically couples the imaging adapter head to the personal imaging device. The imaging adapter head can be mechanically coupled to the personal imaging device using, for example, a corner clip, an elastic band, clamps, a conformable mount, an adhesive present on one or both systems, or any combination of these. The mechanical coupling elements can be configured to substantially secure the imaging adapter head in a fixed position and/or orientation relative to the camera of the personal imaging device. In some embodiments, the personal imaging device has a display that the user can use to visually align the imaging adapter head during the mechanical coupling step. In certain embodiments, the imaging adapter head can use a micro-display and coupling elements to display a visible pattern during alignment. For example, the imaging adapter head can display cross-hairs on the micro-display, and this visible signal can be optically coupled to the camera of the personal imaging device. The user can use the display on the personal imaging device to view the cross-hairs to receive visual feedback about the alignment of the imaging adapter head. Furthermore, the user can use the display to receive visual feedback about the level of focus of the micro-display on the camera of the personal imaging device. In certain embodiments, the mechanical coupling elements include controls for changing the position of the imaging adapter head relative to the camera of the personal imaging device. The controls can provide for movement having 6 degrees of freedom, e.g., translational movement along 3 axes and rotational movement about 3 axes. The controls can provide for fine-tuning the position of the imaging adapter head. The user can use the controls to achieve a desired position of the imaging adapter head such that the micro-display is completely visualized and in focus on the image sensor of the camera on the personal imaging device.

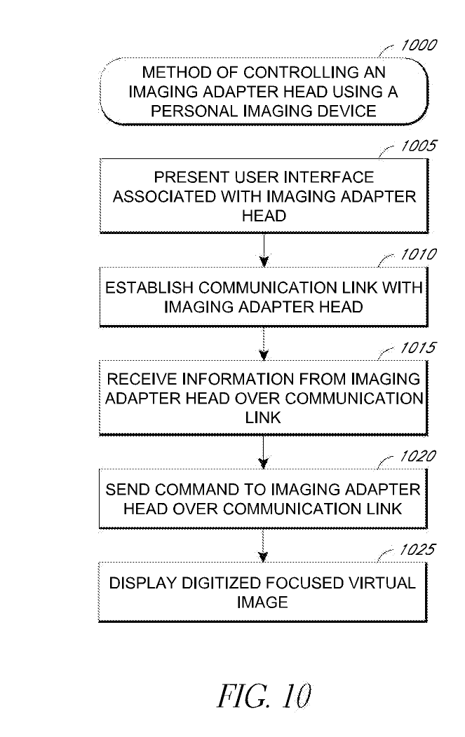

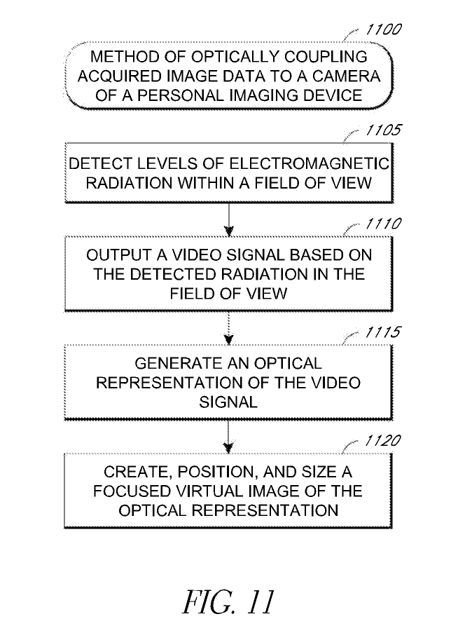

In block 910, the user configures the personal imaging device to display a digitized image. For example, the user can open a program or application on the personal imaging device that allows the user to access images acquired by the personal imaging device camera. The program or application can be configured or designed to be used with the imaging adapter head. The application can allow the user to leverage capabilities of the personal imaging device to perform desired tasks such as, for example, image processing, tagging images or video with GPS information, communicating images to other personal imaging devices or over a network, displaying real-time video from the imaging adapter head, viewing images or video acquired by the imaging adapter head saving images or video, e-mailing images, store date and/or time information with images, storing ambient temperature information from the imaging adapter head, connecting with other applications on the personal imaging device, colorizing images from the micro-display based on calibration data, providing access to adapter controls via the wireless communication link, or any combination of these. In certain embodiments, the application includes user interface elements that allow the user to control the imaging adapter head, as described more fully with reference to FIG. 10. In certain embodiments, the application provides the user the ability to interact with information received from the imaging adapter head. For example, the user can receive calibration data and apply the data to video signals received from the imaging adapter head to colorize a monochromatic signal. In some embodiments, the application provides the ability to the user to use other applications on the personal imaging device. For example, the user can send an image over e-mail using an e-mail application on the personal imaging device.

In block 915, the user establishes a communication link between the personal imaging device and the imaging adapter head. In some embodiments, the communication link is a wireless communication link established between radios of the personal imaging device and the imaging adapter head, as described herein. In some embodiments, the communication link is established over a wired connection between the imaging adapter head and the personal imaging device. The user can request that the personal imaging device establish a communication link with the imaging adapter head through the application or through other means. For example, the imaging adapter head can have a user interface element that allows the imaging adapter head to link to personal imaging devices. Likewise, the personal imaging device can have a user interface that allows the imaging adapter head and the personal imaging device to establish the communication link. In certain embodiments, the act of mechanically coupling the imaging adapter head and the personal imaging device and/or connecting a cable between them establishes the communication link. In certain embodiments, the communications link is automatically established when defined criteria are met. For example, a wireless communications link can be established between the imaging adapter head and the personal imaging device when their respective radios are configured for transmitting and receiving data and are within a suitable distance from one another.

In block 920, the user aims the imaging adapter head at a desired scene to acquire image data. Aiming the imaging adapter head can include positioning and/or orienting the imaging adapter head to permit radiation in a desired field of view to enter the imaging adapter head to be detected and displayed for coupling into the camera of the personal imaging device. The user can request that the imaging adapter head or the personal imaging device acquire image data corresponding to the desired scene. In response to the request, the personal imaging device, the imaging adapter head, or both can acquire image data for storage and/or display. The request can be sent to the imaging adapter head using an application or program on the personal imaging device, using a user interface element on the imaging adapter head, or using a user interface element on the personal imaging device. For example, the personal imaging device can have a physical button such as a shutter button that can be programmed to initiate image acquisition on the personal imaging device or imaging adapter head. In response, the personal imaging device or imaging adapter head can acquire one image, a series of images, or video.

In block 925, using the display of the personal imaging device, the user views a digitized focused virtual image corresponding to acquired image data. The digitized focused virtual image can be a digital representation of a focused virtual image. The digitized focused virtual image can be a result of a focused virtual image being recorded or captured by an optical image sensor on the personal imaging device. The focused virtual image can be created by an optical coupling module of the imaging adapter head and positioned within a depth of field domain of a camera of the personal imaging device. In some embodiments, the imaging adapter head outputs a video signal on the micro-display. The output video signal can correspond to acquired image sensor data or other information as requested by the user. The output video signal can be optically coupled to the camera of the personal imaging device. Optically coupling the video signal can include creating a focused virtual image of the micro-display within a depth of field domain of the camera of the personal imaging device. The optically coupled video signal can be received by the camera of the personal imaging device and displayed to the user.

### Example Method of Controlling an Imaging Adapter Head Using a Personal Imaging Device

FIG. 10 illustrates a flow chart of an example method 1000 for controlling an imaging adapter head using a personal imaging device. The imaging adapter head can be controlled through the personal imaging device, for example, by a user, program, application, or some other means operating through the personal imaging device. Data associated with control commands can be transmitted between the imaging adapter head and the personal imaging device using a communication link. Thus, some embodiments of the imaging adapter head provide for a design that reduces or eliminates physical user interface elements thereby resulting in a small form factor and/or reduced manufacturing cost.

In block 1005, the personal imaging device presents a user interface associated with the imaging adapter head. The user interface can include elements configured to allow a user to interact with the imaging adapter head. For example, elements of the user interface can comprise, without limitation, touch screen buttons, physical buttons on the personal imaging device that are mapped to camera functions, touch screen gestures, physical keyboard or buttons, on-screen display of menu on micro-display, voice control, or any combination of these. The user interface can include a graphical user interface displayed to the user on a display of the personal imaging device. The user interface can include an audible component that audibly indicates a request for input from a user. The user interface can include a speech recognition component that receives voice or audible commands. The user interface can be a part of an application that runs on the personal imaging device.

In block 1010, the personal imaging device establishes a communication link with the imaging adapter head. In certain embodiments, the communication link is a wireless digital data connection. The personal imaging device can include a radio that requests or accepts a wireless digital data connection with a radio on the imaging adapter head. For example, the personal imaging device radio and the imaging adapter head radio can establish a wireless communication link by pairing with one another using according to BLUETOOTH™ Specification Version 3.0+ HS adopted in 2009. In certain embodiments, the communication link is a wired digital data connection. The personal imaging device can include a cable connector (e.g., a USB connector) and the imaging adapter head can include a compatible connector. The personal imaging device can establish a communication link when a cable is inserted into the corresponding connectors on the devices.

In block 1015, the personal imaging device receives information from the imaging adapter head over the established communication link. In some embodiments, the imaging adapter head sends information upon establishing the communication link with the personal imaging device. The personal imaging device can receive this information over the data communication link and process it. The information received can be, for example, battery status, sensor information, micro-display information, calibration data, adapter status, ambient temperature, and the like.

In block 1020, the personal imaging device sends a command to the imaging adapter head over the established communication link. In certain embodiments, the command is selected or composed by a user through the user interface described herein. In certain embodiments, the command is sent to the imaging adapter head through the use of an application on the personal imaging device. In certain embodiments, the command is sent in response to criteria being met on the personal imaging device, such as a timer reaching a defined value. A variety of commands can be sent from the personal imaging device to the imaging adapter head, including, for example, a command that the imaging adapter head acquire an image or video, calibrate the image sensor, display a test pattern, display an alignment pattern, switch modes of operation (e.g., switch spectral band acquisition, dynamic range, color or monochrome display, etc.), zoom (e.g., electronic zoom), or the like. In some embodiments, the personal imaging device receives a response based on the command sent to the imaging adapter head. For example, the imaging adapter head can respond to a command with calibration data, an acknowledgement of receipt of a command, status information (e.g., low battery indication), or the like. In some embodiments, the personal imaging device displays information received over the data communication link to the user on the display.

In block 1025, the personal imaging device displays a digitized focused virtual image corresponding to a focused virtual image. The focused virtual image can correspond to an optical representation of acquired image or video data or other data to be presented to a user from the imaging adapter head. The optical representation can be a video or image output signal from a micro-display on the imaging adapter head. The focused virtual image can be created by an optical coupling module of the imaging adapter head and positioned within a depth of field domain of a camera of the personal imaging device.

Thus, some embodiments advantageously provide for a personal imaging system comprising a personal imaging device and an imaging adapter head, wherein the personal imaging system can receive information over two information links, a data communication link and an optical signal link. The optical signal link can be used to deliver high-bandwidth image or video data, and the data communication link can be used to deliver low-bandwidth non-image data.

### Example Method of Detecting and Displaying Images

FIG. 11 illustrates a flow chart of an example method 1100 for optically coupling acquired image data to a camera of a personal imaging device. The imaging adapter head can be configured to display an optical signal in response to detected radiation in an image sensor. The optical signal can be coupled to a personal imaging device camera for display, processing, and control purposes. For ease of description, the method 1100 is described as being performed by the imaging adapter head. However, steps in the method 1100 can be performed by, for example, a user, components or modules of the imaging adapter head, components or modules of the personal imaging device, and/or another entity.

In block 1105, the imaging adapter head detects levels of electromagnetic radiation within a field of view. The imaging adapter head can include an image sensor module configured to detect levels of electromagnetic radiation in an electromagnetic scene. The image sensor module can be configured to detect electromagnetic radiation having wavelengths from various regions of the electromagnetic spectrum including, for example, thermal radiation, SWIR, NIR, visible radiation, UV radiation, or radiation in other parts of the electromagnetic spectrum. The image sensor module can be sensitive to radiation, for example, having a wavelength of at least about 3 μm and/or less than or equal to about 14 μm, at least about 0.9 μm and/or less than or equal to about 2 μm, at least about 0.7 μm and/or less than or equal to about 1 μm, at least about 1 μm and/or less than or equal to about 3 μm, at least about 3 μm and/or less than or equal to about 5 μm, at least about 7 μm and/or less than or equal to about 14 μm, at least about 8 μm and/or less than or equal to about 14 μm, at least about 8 μm and/or less than or equal to about 12 μm, at least about 0.4 μm and/or less than or equal to about 1 μm, or less than or equal to about 0.4 μm. The image sensor module can be configured to detect low light levels, such as an image intensifying image sensor or image sensor module.

In block 1110, the imaging adapter head outputs a digital or analog video signal representing varying levels of the detected electromagnetic radiation in the field of view. The imaging adapter head can include an imaging module configured to receive information from the image sensor module and convert that information into a desired video signal. For example, the imaging module can receive image sensor data corresponding to levels of electromagnetic radiation and convert that information into temperature information for display on the micro-display. The imaging module can output a video signal according to a video standard, such as, for example, SVGA, UVGA, SXGA, WUXGA, UXGA, VGA, QXGA, WVGA, HD 720, HD 1080, and the like.

In block 1115, the imaging adapter head generates an optical representation of the digital or analog video signal. The imaging adapter head can include a micro-display module configured to display the analog or digital video signal prepared by the imaging module in block 1110. The micro-display module can be configured to display the video signal using a color or monochrome display. The micro-display module can have a viewing area that has a width that is at least about 5 mm and/or less than or equal to about 40 mm, at least about 10 mm and/or less than or equal to about 30 mm, or at least about 16 mm and/or less than or equal to about 20 mm. The viewing area of the micro-display module can have a height that is at least about 4 mm and/or less than or equal to about 30 mm, at least about 7.5 mm and/or less than or equal to about 23 mm, or at least about 12 mm and/or less than or equal to about 15 mm. The viewing area of the micro-display module can be at least about 20 mm² and/or less than or equal to about 1200 mm², at least about 75 mm² and/or less than or equal to about 700 mm², or at least about 190 mm² and/or less than or equal to about 300 mm².

In block 1120, the imaging adapter head creates a focused virtual image of the optical representation and sizes and positions the focused virtual image such that the optical representation of the field of view is completely imaged on an optical image sensor of a mechanically coupled personal imaging device having a camera. The imaging adapter head can include an optical coupling module having one or more lenses or lens groups. The optical coupling module can be configured to create a focused virtual image of the micro-display. The optical coupling module can be configured to position the focus virtual image of the micro-display at a distance that falls within a depth of field domain of a mechanically coupled personal imaging device. For example, the optical coupling module can be configured to position the focused virtual image such that a distance between the focused virtual image and an optical image sensor of a mechanically coupled personal imaging device is greater than a distance between the micro-display and the optical image sensor. In some embodiments, the optical coupling module is configured to size the focused virtual image such that the entire focused virtual image is contained within an optical image sensor of a mechanically coupled personal imaging device camera. In certain embodiments, the components of the optical coupling module have a total refractive power that is positive and the viewing area of the micro-display is positioned inside a focal point of the optical coupling module.

### Example Method of Manufacturing an Imaging Adapter Head

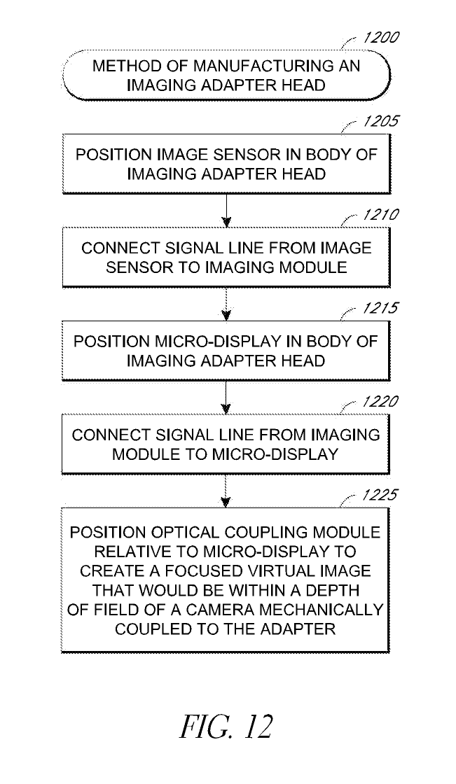

FIG. 12 illustrates a flow chart of an example method 1200 for manufacturing an imaging adapter head. The imaging adapter head can include a micro-display and optical coupling elements configured to optically couple a digital or analog video signal displayed by a micro-display on the imaging adapter head to a camera of a personal imaging device. Manufacturing the imaging adapter head can include arranging components of the imaging adapter head such that levels of electromagnetic radiation detected by an image sensor can be processed and displayed on a micro-display which can be optically coupled to a personal imaging device camera. For ease of description, the method 1200 is described as being performed by a manufacturer. However, steps in the method 1100 can be performed by, for example, a supplier, a seller, a user, or another entity.

In block 1205, the manufacturer positions an image sensor in a body of the imaging adapter head. The image sensor can be positioned such that the image sensor is configured to detect levels of electromagnetic radiation within a field of view. The image sensor can be positioned such that optics associated with, or coupled to, the imaging adapter head can focus electromagnetic radiation from a scene onto the image sensor. The image sensor can be an active pixel sensor (e.g., CMOS sensor) or other similar image sensor (e.g., CCD image sensor) and have a number of pixels. For example, the image sensor can have at least about 1 million pixels and/or less than or equal to about 20 million pixels, at least about 1.5 million pixels and/or less than or equal to about 12 million pixels, or at least about 2 million pixels and/or less than or equal to about 10 million pixels. The image sensor can be configured to detect light from various regions of the electromagnetic spectrum including, for example, thermal radiation, SWIR, NIR, visible radiation, UV radiation, or radiation in other parts of the electromagnetic spectrum.

In block 1210, the manufacturer connects a signal line from the image sensor to an imaging module. The imaging module can include hardware components such as, for example, processors, memory, data storage, controllers, and the like as described herein with reference to FIG. 3. Connecting a signal line can include electrically coupling the image sensor to the imaging module for transmission of electronic data. For example, connecting the signal line can include creating one or more electrical connections between the image sensor and one or more components of the imaging module such that digital or analog electrical signals can propagate between the image sensor and the imaging module.

In block 1215, the manufacturer positions the micro-display in the body of the imaging adapter head. The micro-display can include a display having a relatively small viewing area. For example, the micro-display can be an emissive OLED micro-display based on a CMOS backplane that includes an analog video interface, such as the MICROOLED™ 1.7M pixels MDP01A-P mono white manufactured by MICROOLED of Grenoble, France. The micro-display can have a viewing area that is at least about 20 mm² and/or less than or equal to about 1200 mm², at least about 75 mm² and/or less than or equal to about 700 mm², or at least about 190 mm² and/or less than or equal to about 300 mm². The micro-display can display video information using a monochrome or color display.

In block 1220, the manufacturer connects a signal line from the imaging module to the micro-display. Connecting a signal line can include electrically coupling the imaging module to the micro-display for transmission of electronic data. For example, connecting the signal line can include creating one or more electrical connections between the imaging module and the micro-display such that digital or analog electrical signals can propagate between the imaging module and the micro-display. In some embodiments, the micro-display can have an electrical video input configured to receive video information. The video input can be electrically coupled to one or more components of the imaging module.

In block 1225, the manufacturer positions an optical coupling module relative to the micro-display to create a focused virtual image that would be positioned within a depth of field of a camera mechanically coupled to the imaging adapter head. The optical coupling module can be configured to position and size the focused virtual image such that when the imaging adapter head is coupled to the personal imaging device having an optical image sensor, the focused virtual image is completely imaged on the optical image sensor. In some embodiments, the optical coupling module can be configured to create a focused virtual image that is positioned such that a distance between the focused virtual image and the optical image sensor is greater than a distance between the micro-display and the optical image sensor. The optical coupling module can include optical components that conform to an optical prescription. For example, the optical prescription can indicate the relative positions, curvatures, thicknesses, and indices of refraction for the components in the optical coupling module. The optical prescription can indicate suitable relative positions of the optical module and the micro-display. The optical prescription can be configured to generate a focused virtual image of the micro-display having a defined size and distance. In certain embodiments, the components of the optical coupling module have a total refractive power that is positive. In certain embodiments, the optical coupling module has a focal length and the viewing area of the micro-display is positioned less than one focal length from the optical coupling module.

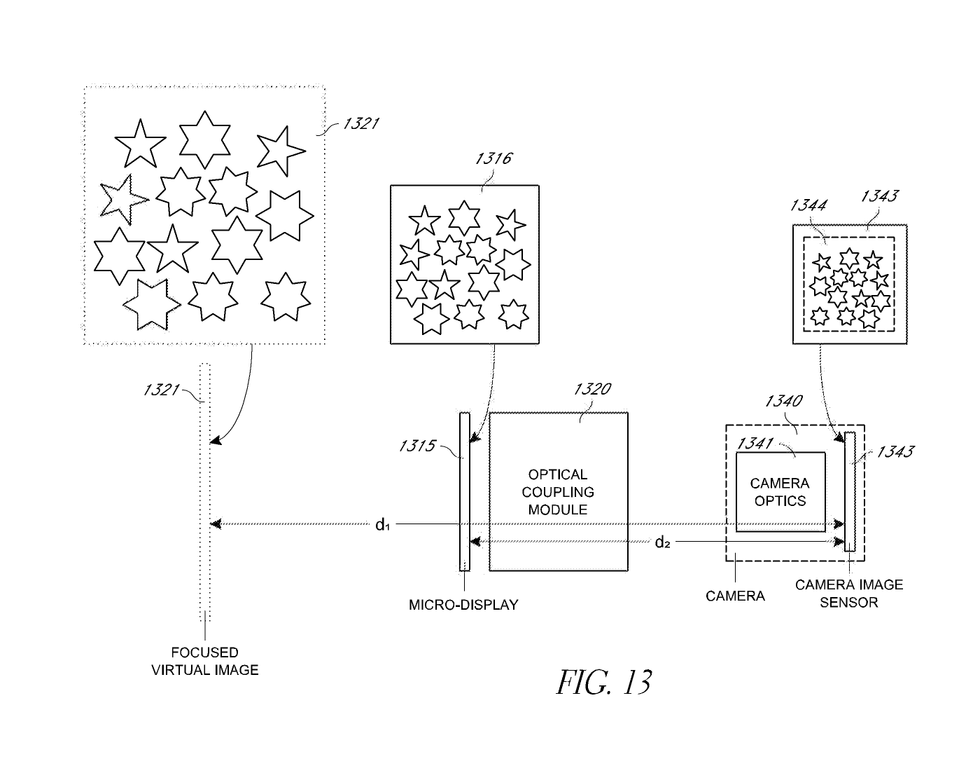

As an example, FIG. 13 illustrates a micro-display 1315 displaying an image 1316. The micro-display 1315 can receive image data corresponding to the image 1316 from an imaging module or from another source. An optical coupling module 1320 creates a focused virtual image 1321 at a distance, d₁, from a camera image sensor 1343 in a camera 1340. The focused virtual image 1321 can be focused by camera optics 1341 onto a camera image sensor 1343. The size of the image 1344 on the camera image sensor 1343 is less than or equal to the size of the camera image sensor 1343. The distance, d₂, from the micro-display 1315 to the camera image sensor 1343 is less than the distance, d₁, from the focused virtual image 1321 to the camera image sensor 1343. As such, the distance, d₁, falls within a depth of field domain of the camera 1340 having the camera optics 1341 and the camera image sensor 1343.

### Example Embodiments

The following is a numbered list of example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

1. An imaging adapter head comprising:
a sensor module configured to detect levels of electromagnetic radiation within a field of view and output a digital or analog video signal representing varying levels of the electromagnetic radiation within the field of view;
a micro-display module configured to receive the digital or analog video signal and to generate an optical representation of the digital or analog video signal on a micro-display having a display image area; and
an optical coupling module having one or more lenses, wherein the one or more lenses are configured to create a focused virtual image of the optical representation and to position and size the focused virtual image such that, when the imaging adapter head is coupled to a personal imaging device having an optical image sensor, the optical representation of the field of view is completely imaged on the optical image sensor and a distance between the focused virtual image and the optical image sensor is greater than a distance between the micro-display and the optical image sensor.

2. The imaging adapter head of embodiment 1, wherein the sensor module is configured to detect levels of electromagnetic radiation having wavelengths between about 8 μm and about 14 μm.

3. The imaging adapter head of any of embodiments 1 to 2, wherein the sensor module is configured to detect levels of electromagnetic radiation using image intensifying components.

4. The imaging adapter head of any of embodiments 1 to 3, wherein the display image area of the micro-display module is less than or equal to about 300 mm².

5. The imaging adapter head of any of embodiments 1 to 4, wherein a width of the display image area of the micro-display module is less than or equal to about 20 mm.

6. The imaging adapter head of any of embodiments 1 to 5, wherein a height of the display image area of the micro-display module is less than or equal to about 15 mm.

7. The imaging adapter head of any of embodiments 1 to 6, wherein the micro-display has greater than or equal to about 1 million independent pixels arranged in a two-dimensional array.

8. The imaging adapter head of any of embodiments 1 to 7, wherein the optical coupling module has a total positive refractive power.

9. The imaging adapter head of embodiment 1, wherein a distance between the micro-display and the optical coupling module is less than a focal length of the optical coupling module.

10. The imaging adapter head of any of embodiments 1 to 9, further comprising a radio module configured to establish a wireless digital communication link with a radio of the personal imaging device.

11. The imaging adapter head of embodiment 10, wherein the radio module is configured to transmit calibration information over the established wireless digital communication link.

12. The imaging adapter head of embodiment 10, wherein the radio module is configured to receive a command to perform a calibration procedure from the personal imaging device over the established wireless digital communication link.

13. The imaging adapter head of any of embodiments 1 to 12, further comprising an imaging module connected to the sensor module and the micro-display module wherein the imaging module is configured to process the digital or analog video signal from the sensor module and to send the processed video signal to the micro-display module.

14. The imaging adapter head of any of embodiments 1 to 13, further comprising a rechargeable battery configured to supply electrical power to the micro-display module.

15. A personal imaging system having an adapter head configured to optically couple a scene into a camera module of a personal imaging device and establish a digital data communications link with the personal imaging device, the system comprising:
a personal imaging device having a personal device radio module and a camera module with an optical image sensor, wherein the camera module has a depth of field domain;
an imaging adapter head configured to operatively couple with the personal imaging device, the imaging adapter head comprising an optical coupling module having one or more lenses, wherein the one or more lenses are configured to create a focused virtual image of a video output and to position the focused virtual image such that the focused virtual image is within the depth of field domain of the camera module; and
an imaging adapter radio module configured to establish a wireless digital data communications link with the personal device radio.

16. The system of embodiment 15, wherein the optical coupling module has a total positive refractive power.

17. The system of embodiment 16, wherein a distance between the micro-display and the optical coupling module is less than a focal length of the optical coupling module.

18. The system of any of embodiments 15 to 17, wherein the imaging adapter radio module is configured to transmit imaging adapter head information over the established wireless digital communication link.

19. The system of any of embodiments 15 to 18, wherein the imaging adapter radio module is configured to receive commands from the personal imaging device over the established wireless digital communication link.

20. A personal imaging system having an adapter head with a micro-display that is optically coupled into a camera module of a personal imaging device, the system comprising:
a personal imaging device comprising:
   a camera module with an optical image sensor configured to generate digital image data, wherein the camera module has a depth of field domain; and
   an imaging interface module configured to generate an image for display based on the digital image data; and
an imaging adapter head configured to operatively couple with the personal imaging device, the imaging adapter head comprising:
   a micro-display module configured to receive a digital or analog video signal and to generate an optical representation of the digital or analog video signal on a micro-display having a display image area; and
   an optical coupling module having one or more lenses, wherein the one or more lenses are configured to create a focused virtual image of a video output and to position the virtual image such that the focused virtual image is within the depth of field domain of the camera module.

21. The personal imaging system of embodiment 21, further comprising a mechanical coupling attachment configured to secure the imaging adapter head to the personal imaging device.

22. The personal imaging system of embodiment 22, wherein the mechanical coupling attachment is configured to position the imaging adapter head relative to the personal imaging device such that the focused virtual image is completely imaged on the optical image sensor.

23. A method of using an imaging adapter head, the method comprising:
mechanically coupling the imaging adapter head to a personal imaging device; and
viewing, on a display of the personal imaging device, a digitized focused virtual image corresponding to a focused virtual image,
wherein an optical coupling module of the imaging adapter head produces the focused virtual image by focusing a video output signal from a micro-display of the imaging adapter head, the video output signal being an optical representation of acquired image data, and
wherein the optical coupling module of the imaging adapter head positions the focused virtual image within a depth of field domain of a camera of the personal imaging device.

24. The method of embodiment 23, further comprising establishing a communication link between the imaging adapter head and the personal imaging device.

25. The method of embodiment 24, wherein the communication link is a wireless communication link.

26. The method of any of embodiments 23 to 25, further comprising aiming the imaging adapter head at a desired scene.

27. The method of any of embodiments 23 to 26, further comprising aligning the imaging adapter head relative to the personal imaging device such that the focused virtual image of the video output is completely imaged on the optical image sensor.

28. The method of embodiment 27, wherein aligning the imaging adapter head comprises:
requesting the imaging adapter head to display an alignment pattern on the micro-display;
viewing the alignment pattern using the display of the personal imaging device; and
adjusting a position of the imaging adapter head relative to the personal imaging device to display the entire alignment pattern on the display of the imaging device.

29. The method of embodiment 27, wherein aligning the imaging adapter head comprises:
requesting the imaging adapter head to display an alignment pattern on the micro-display;
viewing the alignment pattern using the display of the personal imaging device; and
adjusting a position of the imaging adapter head relative to the personal imaging device to center the alignment pattern on the display of the imaging device.

30. The method of any of embodiments 23 to 29, further comprising using the personal imaging device to send a request to the imaging adapter head to perform a calibration procedure.

31. The method of any of embodiments 23 to 30, further comprising using the personal imaging device to acquire an image of the focused virtual image.

32. A method of controlling an imaging adapter head, the method comprising:
presenting a user interface associated with the imaging adapter head;
establishing a communication link with the imaging adapter head;
sending a command to the imaging adapter head over the communication link; and
displaying a digitized focused virtual image corresponding to a focused virtual image, the focused virtual image being produced by an optical coupling module of the imaging adapter head,
wherein the focused virtual image corresponds to a video output signal from a micro-display in the imaging adapter head, and
wherein the optical coupling module positions the focused virtual image within a depth of field domain of a camera of a personal imaging device.

33. The method of embodiment 32, wherein establishing the communication link comprises establishing a wireless communication link between the personal imaging device and the imaging adapter head.

34. A method of optically coupling acquired image data to a camera of a personal imaging device, the method comprising:
detecting levels of electromagnetic radiation within a field of view;
outputting a digital or analog video signal representing the detected levels of electromagnetic radiation within the field of view;
generating an optical representation of the digital or analog video signal;
producing a focused virtual image of the optical representation; and
positioning and sizing the focused virtual image such that the optical representation of the field of view is completely imaged on an optical image sensor of a mechanically coupled personal imaging device having a camera and the focused virtual image is positioned within a depth of field domain of the camera.

35. The method of embodiment 34, wherein detecting levels of electromagnetic radiation within a field of view comprises detecting levels of electromagnetic radiation having a wavelength between about 8 μm and about 14 μm.

36. The method of any of embodiments 34 to 35, wherein generating an optical representation comprises displaying the digital or analog video signal on a micro-display wherein the micro-display has a viewing area that is less than about 300 mm².

37. The method of any of embodiments 34 to 36, further comprising establishing a communication link with the personal imaging device.

38. The method of embodiment 37, wherein the communication link is a wireless communication link.

39. A method of manufacturing an imaging adapter head, the method comprising:
positioning an image sensor in a body of the imaging adapter head such that the image sensor is configured to detect levels of electromagnetic radiation within a field of view;
connecting the image sensor to an imaging module wherein the imaging module comprises at least one processor,
positioning a micro-display having a viewing area in the body of the imaging adapter head;
connecting the imaging module to the micro-display; and
positioning an optical coupling module relative to the micro-display such that the optical coupling module is configured to:
   create a focused virtual image of the viewing area of the micro-display, and
   position and size the focused virtual image such that when the imaging adapter head is coupled to a personal imaging device having an optical image sensor, the focused virtual image is completely imaged on the optical image sensor and a distance between the focused virtual image and the optical image sensor is greater than a distance between the micro-display and the optical image sensor.

40. The method of embodiment 39, wherein the optical coupling module has a total refractive power that is positive.

41. The method of embodiment 40, further comprising positioning the viewing area of the micro-display at a distance from the optical coupling module wherein the distance is less than a focal length of the optical coupling module.

### Conclusion

Many variations on the imaging adapter head 100 described above are possible. For example, although the above description generally describes the imaging module 110 as performing processing data and controlling the imaging adapter head 100, at least some of those functions described can be performed by the various components of the imaging adapter head 100 such as the image sensor 105, the micro-display 110, the radio 125, and/or the power management module 130. Likewise, at least some of the functions described as performed by the image sensor 105, the micro-display 110, the radio 125, and/or the power management module 130 can be performed by the imaging module 110. For example, the imaging module 110 can be configured to perform power management functions.

In some embodiments, the connections between the components shown represent possible paths of data flow, rather than actual connections between hardware. While some examples of possible connections are shown, any of the subset of the components shown can communicate with any other subset of components in various implementations.

It should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Moreover, any components, features, or steps illustrated and/or described in a particular embodiment herein can be applied to or used with any other embodiment(s). Thus, it is intended that the scope of the inventions herein disclosed should not be limited by the particular embodiments described above, but should be determined only by a fair reading of the claims that follow.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z each to be present.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The various illustrative logical blocks, modules, data structures, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, data structures, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, a microcontroller, a state machine, combinations of the same, or the like. A processor may also be implemented as a combination of computing devices—for example, a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a non-transitory computer-readable storage medium such as RAM memory, flash memory, ROM memory, EPROM memory, EEPROM memory, registers, a hard disk, a removable disk, a CD-ROM, memory capable of storing firmware, or any other form of computer-readable storage medium. An exemplary computer-readable storage medium can be coupled to a processor such that the processor can read information from, and write information to, the computer readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

What is claimed is:

1. An imaging adapter head comprising:
a sensor module configured to detect levels of electromagnetic radiation within a field of view and output a digital or analog video signal representing varying levels of the electromagnetic radiation within the field of view;
a micro-display module configured to receive the digital or analog video signal and to generate an optical representation of the digital or analog video signal on a micro-display having a display image area; and
an optical coupling module having one or more lenses, wherein the one or more lenses are configured to create a focused virtual image of the optical representation and to position and size the focused virtual image such that, when the imaging adapter head is coupled to a personal imaging device having an optical image sensor, the optical representation of the field of view is completely imaged on the optical image sensor and a distance between the focused virtual image and the optical image sensor is greater than a distance between the micro-display and the optical image sensor.

2. The imaging adapter head of claim 1, wherein the sensor module is configured to detect levels of electromagnetic radiation having wavelengths between about 8 μm and about 14 μm.

3. The imaging adapter head of claim 1, wherein the sensor module is configured to detect levels of electromagnetic radiation using image intensifying components.

4. The imaging adapter head of claim 1, wherein the display image area of the micro-display module is less than or equal to about 300 mm².

5. The imaging adapter head of claim 1, wherein a width of the display image area of the micro-display module is less than or equal to about 20 mm.

6. The imaging adapter head of claim 1, wherein a height of the display image area of the micro-display module is less than or equal to about 15 mm.

7. The imaging adapter head of claim 1, wherein the micro-display has greater than or equal to about 1 million independent pixels arranged in a two-dimensional array.

8. The imaging adapter head of claim 1, wherein the optical coupling module has a total positive refractive power.

9. The imaging adapter head of claim 8, wherein a distance between the micro-display and the optical coupling module is less than a focal length of the optical coupling module.

10. The imaging adapter head of claim 1, further comprising a radio module configured to establish a wireless digital communication link with a radio of the personal imaging device.

11. The imaging adapter head of claim 10, wherein the radio module is configured to transmit calibration information over the established wireless digital communication link.

12. The imaging adapter head of claim 10, wherein the radio module is configured to receive a command to perform a calibration procedure from the personal imaging device over the established wireless digital communication link.

13. The imaging adapter head of claim 1, further comprising an imaging module connected to the sensor module and the micro-display module wherein the imaging module is configured to process the digital or analog video signal from the sensor module and to send the processed video signal to the micro-display module.

14. The imaging adapter head of claim 1, further comprising a rechargeable battery configured to supply electrical power to the micro-display module.

15. A method of using an imaging adapter head, the method comprising:
mechanically coupling the imaging adapter head to a personal imaging device; and
viewing, on a display of the personal imaging device, a digitized focused virtual image corresponding to a focused virtual image,
wherein an optical coupling module of the imaging adapter head produces the focused virtual image by focusing a video output signal from a micro-display of the imaging adapter head, the video output signal being an optical representation of acquired image data, and
wherein the optical coupling module of the imaging adapter head positions the focused virtual image within a depth of field domain of a camera of the personal imaging device.

16. The method of claim 15, further comprising establishing a communication link between the imaging adapter head and the personal imaging device.

17. The method of claim 16, wherein the communication link is a wireless communication link.

18. The method of claim 15, further comprising aiming the imaging adapter head at a desired scene.

19. The method of claim 15, further comprising aligning the imaging adapter head relative to the personal imaging device such that the focused virtual image of the video output is completely imaged on the optical image sensor.

20. The method of claim 19, wherein aligning the imaging adapter head comprises:
requesting the imaging adapter head to display an alignment pattern on the micro-display;
viewing the alignment pattern using the display of the personal imaging device; and
adjusting a position of the imaging adapter head relative to the personal imaging device to display the entire alignment pattern on the display of the imaging device.

21. The method of claim 19, wherein aligning the imaging adapter head comprises:
requesting the imaging adapter head to display an alignment pattern on the micro-display;
viewing the alignment pattern using the display of the personal imaging device; and
adjusting a position of the imaging adapter head relative to the personal imaging device to center the alignment pattern on the display of the imaging device.

22. The method of claim 15, further comprising using the personal imaging device to send a request to the imaging adapter head to perform a calibration procedure.

23. The method of claim 15, further comprising using the personal imaging device to acquire an image of the focused virtual image.
